(19) United States
(12) Patent Application Publication
(10) Pub. No.: US 2015/0223501 A1
(43) Pub. Date: Aug. 13, 2015

(54) NOVEL FLAVOUR COMPOSITIONS WITH IMPROVED FLAVOUR AND/OR FLAVOUR SHELF-LIFE

(71) Applicant: NESTEC S.A., Vevey (CH)

(72) Inventors: Tuong Huynh-Ba, Pully (CH); Walter Matthey-Doret, Prilly (CH); Florian Viton, Lausanne (CH); Stephanie Devaud Goumoens, Porsel (CH); Candice Marie Menozzi, Lausanne (CH)

(21) Appl. No.: 14/424,082

(22) PCT Filed: Sep. 10, 2013
(86) PCT No.: PCT/EP13/68657

§ 371 Date: Feb. 26, 2015

(30) Foreign Application Priority Data
Sep. 14, 2012 (EP) 12184599.4

(51) Int. Cl. A23L 1/227; A23L 1/226; A23L 1/231; A23L 1/228

(52) U.S. Cl. CPC A23L 1/227; A23L 1/2275; A23L 1/228; A23L 1/22692; A23L 1/231; A23V 2002/00

(57) ABSTRACT

The present invention relates to a novel flavour composition for modulating the flavour of a nutritional product, comprising a mixture of a single amino acid and wet alkane polyol, wherein the single amino acid is selected from the group consisting of ornithine, lysine, glycine, alanine, monosodium glutamate, histidine, threonine, phenylalanine, tyrosine, serine, methionine, arginine, glutamic acid and cysteine. The invention also concerning the use of such a flavour composition for modulating the flavor and/or flavour shelf-life of a nutritional product, the process for preparing such a flavour composition and a nutritional product comprising such a flavour composition.

### FIELD OF THE INVENTION

This invention relates to novel flavour compositions for modulating the flavour and/or flavour shelf-life of a nutritional product and to a process for preparing such flavour compositions. Further, the invention relates to a process for modulating the flavour and/or flavour shelf-life of various nutritional products such as bakery products, beverages, confectionery products, savoury products, cereal products, dairy products, petfood products, etc.

### BACKGROUND OF THE INVENTION

Generally, enhanced intensity, shelf-life, specificity and freshness of flavour is a key consumer preference driver in food products and beverages. It was an aim of the present invention to develop a variety of novel flavour compositions that can be used for providing such favorable properties to nutritional products. In the context of this invention, the term nutritional product refers to any product that is consumable over the mouth by a mammal such as a human or an animal.

It is generally known in the art that process flavours can be produced by Maillard reaction via processing (e.g. heating) of aqueous mixtures of carbohydrates and amino acids in the presence of phosphate buffer. However, a major drawback of said process is the staling of the flavour generated in a very short time, due to the disappearance of the key aroma compounds after heating.

Flavour staling in bread has been tried to be overcome by Wiseblatt L. & Zoumout H. F. (Isolation, origin, and synthesis of a bread flavour constituent. Cereal chemistry, 1963, 40, 162-169), by heating aqueous mixtures of proline with either dihydroxyacetone, glyceraldehydes, α-hydroxycarbonyls such as acetol or 1-hydroxyacetone, or dicarbonyls such as pyruvaldehyde. The proline-dihydroxacetone product has been described as being advantageous over the other amino acids tested with regard to the persistence of the cracker aroma in bread.

An approach to enhance the flavour and aroma of bakery products was reported by U.S. Pat. No. 3,547,659 to Hoffmann La Roche, by heating a mixture of several amino acids in neat glycerol or propylene glycol to generate a bread-like flavour. However, the preparation method involves merely heating the mixture at a temperature elevated above room temperature without the addition of water.

EP 1383397 B1 assigned to Nestle discloses a process for preparing flavour concentrates for use in chocolate to give a caramel and/or biscuit/cookie flavour. The process includes the step of adding a mixture of flavour precursors comprising proline, ornithine or protein hydrolysate, and rhamnose, fucose or fructose, to a fat-based medium and heating the mixture to about 100-140 degrees centigrade for about 10-120 minutes to form a flavour concentrate.

Finally, a high flavour intensity has been tried to be conferred to chicken flavourings in U.S. Pat. No. 4,592,917 assigned to Nestec. The chicken flavourants are prepared by reacting a mixture of leucine and/or its salts with a sulfur-containing compound and a reducing saccharide in the presence of a hydroxylated solvent. Again a mixture of amino acids has been used as well as of large amounts of sugar.

Although some of the above combinations of ingredients have been described as enhancing the flavour and aroma of foodstuff there is still a need to improve flavour properties in those products, and in particular to prolong the shelf-life, specificity and freshness of flavour in nutritional products.

### SUMMARY OF THE INVENTION

It has been surprisingly found by the applicant that aroma properties of nutritional products can be improved, and flavour staling in such products can be overcome by incorporating a flavour system comprising a single amino acid and wet alkane polyol. Moreover, the use of different single amino acid/wet alkane polyol combinations has been found to generate aroma compounds of different flavour profiles with improved and prolonged shelf-life. Optionally, a reducing agent is included into the mixture of wet alkane polyol and single amino acid.

Accordingly, in a first aspect, the present invention provides a flavour composition for modulating the flavour of a nutritional product, comprising a mixture of a single amino acid and wet alkane polyol, wherein the single amino acid is selected from the group consisting of ornithine, lysine, glycine, alanine, monosodium glutamate, histidine, threonine, phenylalanine, tyrosine, serine, methionine, arginine, glutamic acid and cysteine.

A second aspect of the invention relates to the use of a flavour composition according to the first aspect of the invention for modulating the flavour and/or flavour shelf-life of a nutritional product.

In a third aspect, the invention provides a process for preparing a flavour composition, comprising
(a) Preparing a mixture comprising
   i. wet alkane polyol, preferably in an amount of from 99.9 to 75 wt %, more preferably from 99.5 to 85 wt %, and even more preferably from 99 to 90 wt %, calculated on the weight of the flavour composition,
   ii. a single amino acid, preferably in an amount of from 0.1 to 25 wt %, more preferably from 0.5 to 15 wt %, and even more preferably from 1 to 10 wt %, calculated on the weight of the flavour composition, and
   iii. optionally at least one reducing agent, preferably in an amount of 0.0001% to 1% calculated on the weight of the single amino acid,
      wherein the single amino acid is selected from the group consisting of ornithine, lysine, glycine, alanine, monosodium glutamate, histidine, threonine, phenylalanine, tyrosine, serine, methionine, arginine, glutamic acid and cysteine;
(b) Optionally adjusting the pH of the mixture, preferably to a pH of from 6.5 to 8.0, more preferably to a pH of from 7 to 7.9;
(c) Heating the mixture in water, preferably for a period of 5 minutes to 5 hours, preferably at a temperature of from 70° C. to 250° C.;
(d) Optionally adjusting the pH of the heated mixture, preferably to a pH of from 6.5 to 8.0, more preferably to a pH of from 7 to 7.9.

In a fourth aspect, the invention provides a process for modulating the flavour and/or flavour shelf-life of a nutritional product, comprising (a) Preparing one or more flavour compositions by the process according to the third aspect of the invention, and (b) Incorporating the one or more flavour compositions into the nutritional product, preferably prior to cooking and/or processing of said product.

In a fifth aspect, the invention relates to a nutritional product comprising a flavour composition according to the first aspect of the invention, wherein the nutritional product is preferably selected from bakery products, confectionery products, preferably ice confectionery products, most preferably ice cream, savoury products, cereal products, preferably baked cereal products and/or extruded cereal products, dairy products, petfood products, preferably baked petfood products and/or extruded petfood products and beverages.

Preferred embodiments of the above aspects are further specified in the claims.

### DETAILED DESCRIPTION OF THE INVENTION

It has been unexpectedly found by the applicant that the presence of water together with a single amino acid and an alkane polyol improves the flavour properties and in particular prolongs the flavour shelf life over time in nutritional products. More particularly, water has been found to be an essential ingredient of the system comprising an alkane polyol and a single amino acid for the generation of key aroma compounds, namely methylpyrazines such as trimethylpyrazine (caramel and cocoa notes), 2,5-dimethylpyrazine (raw potato and nutty notes), 2,6-dimethylpyrazine (nutty and cocoa notes), 2,3-dimethylpyrazine (caramel, cocoa and coffee notes) and 2-methylpyrazine (popcorn), 2-ethyl-6-methylpyrazine (hazelnut and roasty notes) and tetramethylpyrazines (cocoa, earthy and roasty notes).

Accordingly, in a first aspect the invention concerns a flavour composition for modulating the flavour of a nutritional product, comprising a mixture of a single amino acid and wet alkane polyol, wherein the single amino acid is selected from the group consisting of ornithine, lysine, glycine, alanine, monosodium glutamate, histidine, threonine, phenylalanine, tyrosine, serine, methionine, arginine, glutamic acid and cysteine.

In a preferred embodiment of the first aspect of the invention, the wet alkane polyol is selected from the group consisting of wet glycerol, wet sorbitol, wet xylitol, wet erythritol, wet propane-1,2-diol, wet ethane-1,2-diol, more preferably from the group consisting of wet glycerol, wet sorbitol, wet propane-1,2-diol, and wet ethane-1,2-diol. It is mostly preferred that the wet alkane polyol comprised in the inventive composition is wet glycerol.

What is meant by wet alkane polyol is a mixture of alkane polyol and water, wherein the wet alkane polyol is comprised of alkane polyol and water, preferably in a ratio of from 99:1 to 50:50, more preferably, from 97:3 to 70:30, and most preferably from 96:4 to 80:20.

In a further preferred embodiment of the flavour composition of the invention, the weight ratio of the single amino acid and wet alkane polyol is from 1:10 to 1:100, preferably from 1:20 to 1:80 and more preferably from 1:30 to 1:60.

According to a particular embodiment of the invention, the wet alkane polyol and the single amino acid are pre-reacted for a period of 5 minutes to 5 hours, at a temperature of 70 to 250° C. An especially preferred pre-reaction time is from 30 minutes to 4 hours, e.g. 2 hours. The reaction temperature is most preferably in the region of 80-150° C., e.g. 120° C.

In another preferred embodiment, the flavour composition of the first aspect of the invention further comprises at least one reducing agent, preferably in an amount of 0.0001 to 1% calculated on the weight of the single amino acid.

In the context of the present invention, a reducing agent is an agent that can reduce a test reagent, e.g., can reduce Cu²⁺ to Cu⁺, or can be oxidized by such reagents. Suitable reducing agents include uronic acids (e.g., glucuronic acid and galacturonic acid) or Maillard reaction intermediates bearing at least one carbonyl group such as aldehydes, ketones, alpha-hydroxycarbonyl (glyceraldehyde, dihydoxyacetone) or dicarbonyl compounds. Furthermore, sugars may have reducing properties. Reducing sugars include aldoses or ketoses.

It is particularly preferred that the at least one reducing agent is a reducing sugar, which is preferably selected from the group consisting of mono- di- and oligo-saccharides, more preferably from the group consisting of glucose, rhamnose, fucose, sucrose, maltose, lactose, xylose, ribose, mannose, erythrose, threose and galactose, and most preferably from the group consisting of glucose, rhamnose, fucose, sucrose, xylose, ribose, erythrose and threose.

In another preferred embodiment of the inventive flavour composition, the wet alkane polyol is comprised in an amount of from 99.9 to 75 wt %, preferably from 99.5 to 85 wt %, and more preferably from 99 to 90 wt % calculated on the weight of the flavour composition.

It is further preferred that the single amino acid is comprised, preferably in an amount of from 0.1 to 25 wt %, more preferably from 0.5 to 15 wt %, and even more preferably from 1 to 10 wt %, calculated on the weight of the flavour composition.

In a further embodiment of the inventive flavour composition, the single amino acid is preferably selected from the group consisting of ornithine, lysine and glycine.

In another embodiment of the inventive flavour composition according to the first aspect of the invention, the single amino acid is preferably selected from the group consisting of alanine, monosodium glutamate, glutamic acid, histidine and threonine.

In yet another embodiment of the first aspect of the invention, the single amino acid is phenylalanine.

In yet another embodiment of said aspect, the single amino acid is selected from methionine or serine.

Another embodiment relates to a flavour composition according to the first aspect of the invention, wherein the single amino acid is cysteine.

Yet another embodiment relates to a flavour composition according to the first aspect of the invention, wherein the single amino acid is arginine.

The wet alkane polyol/single amino acid systems according to the above embodiments provide very diverse volatile profiles due to the structural and chemical diversities of the amino acids. Depending on the combination of wet alkane polyol and amino acid, the flavour profiles are driven by the large number of methylpyrazines and also by the volatiles specifically generated with the amino acid involved (eg. H₂S with cysteine).

Generally, the flavour compositions according to the first aspect of the invention are suited for modulating the flavour and/or flavour shelf life of a nutritional product, wherein said flavour is selected from: bread, nutty, peanut, cocoa, floral, meaty, sulfury, eggy, grilled, potato, popcorn, caramel, bread crumbs, toasty, bread, old dry wood, cheese, fishy, basmati, and biscuit.

In a second aspect, the invention therefore relates also to the use of a flavour composition according to the above first aspect of the invention, for modulating the flavour and/or flavour shelf-life of a nutritional product. As used herein, the term shelf life refers to the long-lastingness of the perceived flavour over time with limited losses of the key aroma compounds.

In particular, the second aspect relates to the use of an inventive flavour composition according to the first aspect of the invention, wherein the single amino acid is selected from the group consisting of ornithine, lysine and glycine, for modulating the flavour and/or flavour shelf-life of a nutritional product, wherein the flavour is selected from bread notes.

In another embodiment of the second aspect, the invention concerns the use of an inventive flavour composition according to the first aspect of the invention, wherein the single amino acid is selected from the group consisting of alanine, monosodium glutamate, glutamic acid, histidine and threonine, for modulating the flavour and/or flavour shelf-life of a nutritional product, wherein the flavour is selected from nutty and peanut notes.

A further embodiment relates to the use of a flavour composition according to the first aspect of the invention, wherein the single amino acid is phenylalanine, for modulating the flavour and/or flavour shelf-life of a nutritional product, wherein the flavour is selected from cocoa and floral aroma.

In another embodiment of the invention, a flavour composition according to the first aspect, wherein the single amino acid is selected from methionine or serine, is used for modulating the flavour and/or flavour shelf-life of a nutritional product, wherein the flavour is selected from meaty notes.

A flavour composition according to the first aspect of the invention, wherein the single amino acid is cysteine, may be used for modulating the flavour and/or flavour shelf-life of a nutritional product, wherein the flavour is selected from sulfury and eggy notes.

The invention further relates to the use of a flavour composition according to the first aspect, wherein the single amino acid is arginine, for modulating the flavour and/or flavour shelf-life of a nutritional product, wherein the flavour is selected from fishy and cheese notes.

As used herein, the term nutritional product is to be understood as referring to any product that is consumable over the mouth by a mammal such as a human or animal.

In the context of the present invention the nutritional product is preferably selected from the group consisting of bakery products, confectionery products, preferably ice confectionery products, most preferably ice cream, savoury products, cereal products, preferably baked cereal products and/or extruded cereal products, dairy products, petfood products, preferably baked petfood products and/or extruded petfood products and beverages.

In a preferred embodiment the nutritional product according to the invention is a bakery product.

The term “bakery product” refers to a number of products. As used herein, it is used to mean baked goods and baking mixes, including all ready-to-eat and ready-to-bake products, flours, and mixes requiring preparation before serving. The ingredients of bakery products vary, depending on the product in question. The bakery products of the present invention comprise at least the following ingredients, namely water and flour. The bakery product may also comprise an emulsifier. The bakery products of the present invention typically will also include sugars and/or sweeteners and fat and a wide variety of natural and artificial flavourings and colorants well known in the art. Other ingredients including other nutritive substances, preservatives, anti-oxidants and fillers or yeast may also be present. Bakery products can be either baked to completion or left in a semi-baked state, after which a short period of extra time is needed for the final baking. Bakery products can also be left in unbaked state until further use. Freezing can be used to preserve an unbaked product.

The term “baked product” refers to products cooked by heat in a traditional oven or by using a microwave oven, or by any other heating or cooking process including but not limited to ohmic cooking, radio frequency cooking and extrusion cooking.

As used herein, the term dough refers to an unbaked mixture of flour, water and other ingredients, which mixture is a precursor to making a bakery product.

When the bakery product is a dough, the dough can be used to bake products into the form of breads, rolls, pretzels and other bready products and to make other more complex products such as pies, pizzas, calzones, etc.

The dough can be baked in a microwave oven, with or without a susceptor, and in thermal ovens or combination microwave or thermal ovens to form a moist, bready product having a crispy exterior crust.

Bakery products according to the invention include bread, pizza, bagels, patisserie, confectionery wafers (e.g. with low or no sugar), ice cream wafer cones (with high amount of sugar) and biscuits (cookies), as well as cakes and baked confectionery, such as brownies. Included within the definition of bakery products according to the invention are cereal-based products e.g. expanded extruded cereals.

In a particularly preferred embodiment of the invention the nutritional product is a biscuit or a wafer.

When the baked product is a wafer, the wafer may be a flat wafer either having geometric shapes or cartoons character shapes, as well as alphabet letters or numbers, for example. It can also be a three dimensional shaped wafer such as, for example, a cone, a glass, a dish.

Most preferably, the bakery product is an edible container for a frozen confection, in particular a wafer cone.

The bakery product may contain additional ingredients.

According to a particular embodiment, the product contains from 2 to 30% by weight of sugars and/or sweeteners. Sugars comprise monosaccharides, disaccharides, oligosaccharides, polysaccharides including but not limited to glucose, fructose, rhamnose, sucrose, maltose, lactose, arabinose, xylose, ribose, mannose, erythrose, threose and galactose. Sweeteners include plant derived nutritive sweeteners and non-nutritive high intensity sweeteners. Preferably, the bakery product containing from 2 to 30% sugars and/or sweeteners is a wafer cone for frozen confections. Sugar plays a key role in the flexibility of rolled cones. In the still hot wafer sheet, the sugar is liquid or plastic thus giving the wafer sheet its plasticity. Upon cooling, the plasticity is lost and the wafer sheet solidifies into the shape given.

The dough for the bakery product may contain a rising agent, such as yeast or sodium bicarbonate (baking soda).

The dough may also contain eggs and a source of fat, e.g. butter or margarine, or vegetable oils, e.g. sunflower oil, etc.

A wafer batter usually comprises around 40-50% flour, for example wheat flour, which itself contains approximately 70% of starch mainly occurring in the form of granules. In some batters, starch may be added in addition to the flour. The batter may also comprise at least one of the following ingredients: fat and/or oil, lecithin and/or emulsifiers, whole egg, salt, sodium bicarbonate, ammonium bicarbonate, skim milk powder, soy flour, yeast, and/or enzymes such as xylanases or proteases, for example. Any standard wafer batter may be used in accordance with the invention.

A wafer of the present invention may be prepared by any method known to the skilled person. Manufacturing wafers consists in preparing a batter containing mainly flour and water to which other minor ingredients may be added. Typically 40 to 50% flour in batter is used in the manufacture of commercial flat wafers. In the wafer manufacture, after preparation the batter is usually cooked between two heated engraved metal plates for a determined time at a certain temperature, for instance 2 min at 160 C, to produce large flat wafer sheets with a low moisture level. After cooling, the wafers are processed according to the requirements of the final product.

In the field of frozen confectionery, wafer cones are used as an edible container for e.g. ice cream. Two principal types of conventional cones are known: moulded cones and rolled or sugar cones. Moulded cones are produced by baking the batter in a mould that determines the final shape of the cone. The finished cone is removed as a largely dry and form stable product having brittle characteristics. Rolled cones are produced by baking the batter between flat baking moulds and immediately afterwards shaping the still hot wafer sheet into its final cone shape. The batter is first dosed onto the baking base plate, then the cover baking plate is closed. During closing, the batter gets spread out between the plates into the final form of the wafer sheet. After the baking process, the plates are opened again to remove the baked wafer sheet. Right after opening the baking plates, the wafer sheet is still hot but also flexible and can be shaped without breaking into a cone shape. Shaping is done by rolling the sheets around a conical tool where the cone cools down quickly and solidifies, resulting in a largely dry and form stable product also having brittle characteristics.

When the invention relates to cereal based products, the composition of these products may comprise an expanded starch based material, for example potato starch or an expanded cereal material, such as corn, wheat, rice, barley, rye or oat. The expanded extruded cereal product may have a high-, low- or zero-sugar content. When making an expanded extruded cereal product a dough is formed by hydration of starch polymers. In addition to the starch based material (e.g. flour) and water, the dough may also comprise one or more of the following ingredients: soya isolate, milk powder, salt, calcium carbonate, oils and fats, such as hardened palm kernel oil, and flavourings. Any standard dough may be used in accordance with the invention. The density of expanded extruded cereal products according to the invention is preferably from 40 to 500 g/I.

An expanded extruded cereal product of the present invention may be prepared by any method known to the skilled person. For example, the moisture-resistant expanded extruded cereal product may be prepared by a process comprising the steps of making a dough by mixing at least flour and water. The dough may be fed into an extruder in which it may be further mixed and cooked. Cooking may be carried out at temperatures typically from 130 to 170° C., under 8 to 15 MPa. Under these conditions, the water in the dough is superheated whilst the dough is cooked. The cooked mixture is conveyed to the die where it is extruded through openings in the die. When the water-containing mixture, initially at high temperature and pressure, arrives at the die, water vaporises causing the extrudate to expand rapidly creating a foam structure. Traditionally, the extruded product directly expands by the instantaneous conversion of compressed liquid vapour into steam as the product flows through the die and into an ambient environment (moisture flash off process). The product is then dried to low moisture levels to stabilise it as a hard brittle structure.

The wafer or the expanded extruded cereal product of the invention can be presented to the consumer as a wafer or an expanded extruded cereal product by itself, but it can also be associated with another component to provide a composite food product. Therefore, the present invention also relates to a composite food product comprising a moisture-resistant wafer or an expanded extruded cereal product as described above in contact with another food material. The other food material may be a confectionery or savoury food product. Conventional food materials may be used and examples of suitable food materials are chocolate, jelly, compound chocolate, ice-cream, sorbet, nut paste, cream-based products, cake, mousse, nougat, caramel, praline, jam, wafer rework or a combination of these ingredients with or without inclusions of the same ingredient in a different state or of a different ingredient. For savoury products suitable food materials would include fish or meat paste, cheese-based materials or vegetable puree. Such a food product may include one or more of these other materials as fillings for the wafer or expanded extruded cereal product.

It is also possible to use the wafer or expanded extruded cereal product as the centre or part of the centre of a confectionery or savoury product. The wafer or expanded extruded cereal product may be enrobed or moulded in the coating material which can be any of the usual coatings, for example a chocolate, compound, icing, caramel or combinations of these. Preferably the food product is a confectionery product.

A wafer, biscuit or expanded extruded cereal product according to the invention can also be evenly distributed in a confectionery or savoury product. The invention particularly relates to a frozen confectionery product such as an ice cream comprising a wafer, biscuit or cereal product according to the invention in the form of inclusions.

In a third aspect, the invention provides a process for preparing a flavour composition, comprising
(a) Preparing a mixture comprising
   i. wet alkane polyol, preferably in an amount of from 99.9 to 75 wt %, more preferably from 99.5 to 85 wt %, and even more preferably from 99 to 90 wt %, calculated on the weight of the flavour composition,
   ii. a single amino acid, preferably in an amount of from 0.1 to 25 wt %, more preferably from 0.5 to 15 wt %, and even more preferably from 1 to 10 wt %, calculated on the weight of the flavour composition, and
   iii. optionally at least one reducing agent, preferably in an amount of 0.0001% to 1% calculated on the weight of the single amino acid,
      wherein the single amino acid is selected from the group consisting of ornithine, lysine, glycine, alanine, monosodium glutamate, histidine, threonine, phenylalanine, tyrosine, serine, methionine, arginine, glutamic acid and cysteine
(b) Optionally adjusting the pH of the mixture, preferably to a pH of from 6.5 to 8.0, more preferably to a pH of from 7 to 7.9;
(c) Heating the mixture in water, preferably for a period of 5 minutes to 5 hours, preferably at a temperature of from 70° C. to 250° C.;
(d) Optionally adjusting the pH of the heated mixture, preferably to a pH of from 6.5 to 8.0, more preferably to a pH of from 7 to 7.9.

It has been found that adjusting the pH of the reaction before and after the heating treatment to the above specified values has an impact on the formation of the desired aroma compounds and on the release of the desired pyrazine volatiles, respectively.

In the process according to the third aspect of the invention, an especially preferred reaction time is from 30 minutes to 4 hours, e.g. 2 hours. The reaction temperature is most preferably in the region of 80-150° C., e.g. 120° C.

In an embodiment of the process according to the third aspect of the invention, the at least one reducing agent is a reducing sugar, preferably selected from the group consisting of mono- di- and oligo-saccharides, more preferably from the group consisting of glucose, rhamnose, fucose, sucrose, maltose, lactose, xylose, ribose, mannose, erythrose, threose and galactose, and more preferably selected from the group consisting of glucose, rhamnose, fucose, sucrose, xylose, ribose, erythrose and threose.

In a preferred embodiment of the process according to the third aspect of the invention, the wet alkane polyol is selected from the group consisting of wet glycerol, wet sorbitol, wet xylitol, wet erythritol, wet propane-1,2-diol, wet ethane-1,2-diol, more preferably from the group consisting of wet glycerol, wet sorbitol, wet propane-1,2-diol, and wet ethane-1,2-diol. Most preferably, wet glycerol is used.

It is further preferred that in the process according to the third aspect of the invention, the wet alkane polyol is comprised of alkane polyol and water, preferably in a ratio of from 99:1 to 50:50, more preferably from 97:3 to 70:30, and most preferably from 96:4 to 80:20.

Further, it is preferred in any of the above embodiments that the weight ratio of the single amino acid and wet alkane polyol is from 1:10 to 1:100, preferably from 1:20 to 1:80 and more preferably from 1:30 to 1:60.

Generally, the flavour compositions prepared by a process according to the third aspect of the invention are suited for modulating the flavour and/or flavour shelf-life of a nutritional product, wherein said flavour is selected from: bread, nutty, peanut, cocoa, floral, meaty, sulfury, eggy, grilled, potato, popcorn, caramel, bread crumbs, toasty, bread, old dry wood, cheese, fishy, basmati, and biscuit.

In a further embodiment of the third aspect of the invention, the single amino acid is preferably selected from the group consisting of ornithine, lysine and glycine. By such a process a flavour composition may be prepared, which is suited for modulating the flavour and/or flavour shelf-life of a nutritional product, wherein the flavour is selected from bread notes.

In another embodiment of the inventive process according to the third aspect of the invention, the single amino acid is preferably selected from the group consisting of alanine, monosodium glutamate, glutamic acid, histidine and threonine. By such a process, a flavour composition may be provided that is suited for modulating the flavour and/or flavour shelf-life of a nutritional product, wherein the flavour is selected from nutty and peanut notes.

In yet another embodiment of the process according to the third aspect of the invention, the single amino acid is phenylalanine, which process provides a flavour composition which is suited for modulating the flavour and/or flavour shelf-life of a nutritional product, wherein the flavour is selected from cocoa and floral aroma.

In yet another embodiment of said third aspect, the single amino acid is selected from methionine or serine. By said process a flavour composition may be prepared, which is suited for modulating the flavour and/or flavour shelf-life of a nutritional product, wherein the flavour is selected from meaty notes.

Another embodiment relates to a process according to the third aspect of the invention, wherein the single amino acid is cysteine, for preparing a flavour composition for modulating the flavour and/or flavour shelf-life of a nutritional product, wherein the flavour is selected from sulfury and eggy notes.

Yet another embodiment relates to a process according to the third aspect of the invention, wherein the single amino acid is arginine. Such a process provides a flavour composition that is suited for modulating the flavour and/or flavour shelf-life of a nutritional product, wherein the flavour is selected from fishy and cheese notes.

The term nutritional product is to be understood as defined above for the first aspect of the invention, including all of the above specified preferred embodiments.

A fourth aspect of the invention relates to a process for modulating the flavour and/or flavour shelf-life of a nutritional product, comprising (a) Preparing one or more flavour compositions by the process according to the third aspect of the invention, and (b) Incorporating the one or more flavour compositions into the nutritional product, preferably prior to cooking and/or processing of said product.

In an embodiment of the fourth aspect of the invention, the nutritional product is selected from the group consisting of bakery products, confectionery products, preferably ice confectionery products, most preferably ice cream, savoury products, cereal products, preferably baked cereal products and/or extruded cereal products, dairy products, petfood products, preferably baked petfood products and/or extruded petfood products and beverages.

Again, the term nutritional product is to be understood as defined above for the first aspect of the invention, including each of the above specified preferred embodiments. Accordingly, it is mostly preferred that the nutritional product of the invention is a bakery product as defined above. It is also preferred that the bakery product is selected from biscuits and wafers, and preferably is a wafer cone.

In the process according to the fourth aspect of the invention, the flavour is preferably selected from: bread, nutty, peanut, cocoa, floral, meaty, sulfury, eggy, grilled, potato, popcorn, caramel, bread crumbs, toasty, bread, old dry wood, cheese, fishy, basmati, biscuit. Again, the specific kind of flavour depends on the choice of the type of wet alkane polyol/single amino acid system as described above.

In particular, it was surprisingly found by the applicant that the specific wet alkane polyol/single amino acid systems according to the invention provide very diverse sensory profiles due to the structural and chemical diversities of the amino acids. Bread notes were perceived when using ornithine, lysine and glycine and proline, while pronounced nutty and peanut notes were obtained from alanine, monosodium glutamate, glutamic acid, histidine and threonine. Moreover, the combination wet alkane polyol/phenylalanine generated cocoa and floral aroma, meaty note was obtained with serine or methionine, and cysteine gave sulfury and eggy odor due to the formation of H₂S during the thermal process. Finally, fishy and cheese notes were obtained from the combination of wet alkane polyol and arginine. According to these different systems, the flavour profiles were driven by the large number of methylpyrazines as displayed in Table 1, and also by the volatiles specifically generated from the amino-acid involved (eg. H₂S with cysteine).

In a fifth aspect, the invention concerns a nutritional product comprising a flavour composition according to any of the embodiments of the first aspect of the invention. Again, the term nutritional product is to be understood as defined above for the first aspect of the invention. Accordingly, it is also preferred in the fifth aspect of the invention that the nutritional product of the invention is a bakery product as specified above, which is preferably selected from biscuits and wafers, and preferably is a wafer cone.

The invention will now be illustrated in the following examples that should not be considered as limiting the invention.

### EXAMPLES

### Example 1

### Flavour Compositions According to the Invention Comprising Different Types of Amino Acids, Glycerol and Water

### Recipe

Recipe to produce 45 g of flavour composition according to the invention, illustrated with the amino acid proline: A mixture of proline (1.098 g), glycerol (37.314 g) and Vittel water (6.579 g) in a round flask was mechanically stirred for 2 h at room temperature and then heated for 2 h in an oil bath preheated at 120° C.

### Analytical Method

The fiber (SPME Fiber PDMS-DVB 65 μm 23 gauge needle, Supelco N^{o} 57345-U) was exposed for 10 min at 30° C. to the headspace above the samples for 10 min at 30° C. After sampling, the fiber was transported into the injector port in splitless mode at 250° C. for 5 min to desorb and transfer volatile compounds into the chromatographic column. The injector was equipped with a 0.75 mm i.d. liner (Supelco). Gas chromatography (GC) separation was done on a HP-5MS column of 30 m length, 0.25 mm ID and 0.25 μm film thickness (Agilent N^{o} 190915-433). The GC oven temperature program (Agilent Technologies 6890 GC oven) started at 30° C. during 3 min then heated at a rate of 6° C./min up to 240° C. and held for 15 min. The GC was coupled to a mass spectrometry (MS) (Agilent Technologies 5973) mass selective detector operating in EI/TIC (70 eV) mode.

### Flavour Quality

Technical sensory evaluation (sniffing) of flavour compositions was carried out with a panel of 5 to 10 members used to evaluate the aroma quality of flavour compositions. The samples were evaluated separately by the panelists who then shared their descriptions. The overall aroma described here represents the consensus reached by the panelists regarding the aroma quality of the flavour compositions evaluated.

### Analytical and Sensory Results

Volatiles analysis and technical sniffing were performed as described above. The results are shown in the Table 1.

TABLE 1

| Alkane | | | Overall |
|---|---|---|---|
| polyol | Amino acid | Volatile compounds | aroma |
| Glycerol | Proline | 2-Acetylpyrroline, | Popcorn, |
| | | 2-Acetyl-3,4,5,6-tetra- | Bread |
| | | hydropyridine, | |
| | | 2-Acetyl-1,4,5,6-tetra- | |
| | | hydropyridine | |
| Glycerol | Ornithine | 2-Methylpyrazine | Bread- |
| | | | crumbs |
| Glycerol | Monosodium | 2-Methylpyrazine, | Nutty |
| | glutamate | 2,5-Dimethylpyrazine | |
| | | 2,3-Dimethylpyrazine, | |
| | | 2,6-Dimethylpyrazine, | |
| | | Trimethylpyrazine | |
| Glycerol | Phenylalanine | 2-Methylpyrazine, | Cocoa, |
| | | 2,5-Dimethylpyrazine | floral |
| | | Trimethylpyrazine, | |
| | | Benzaldehyde | |
| Glycerol | Methionine | 2-Methylpyrazine, | Potato, |
| | | 2,5-Dimethylpyrazine | meaty |
| | | 2,3-Dimethylpyrazine, | |
| | | 2,6-Dimethylpyrazine, | |
| | | Trimethylpyrazine, | |
| | | Trimethylsulfide | |

### Example 2

### Flavour Compositions According to the Invention Comprising Different Types of Amino Acids, Sorbitol and Water

### Recipe

Recipe to produce 4.1 g of flavour composition according to the invention, illustrated with the amino acid monosodium glutamate: A mixture of monosodium glutamate (0.1 g), sorbitol (3.4 g) and Vittel water (0.6 g) in a round flask was mechanically stirred for 2 h at room temperature and then heated for 2 h in an oil bath preheated at 120° C.

### Analytical Method

The method described in Example 1 was applied.

### Flavour Quality

Sensory evaluation of flavour compositions was carried out with a panel of 5 to 10 members as described in Example 1.

### Analytical and Sensory Results

Volatile analysis and technical sniffing were performed as described above. The results are shown in the Table 2.

TABLE 2

| Alkane | | | Overall |
|---|---|---|---|
| polyol | Amino acid | Volatile compounds | aroma |
| Sorbitol | Monosodium | 2,5-Dimethylpyrazine, | Biscuit |
| | glutamate | 2-Ethyl-5-methylpyrazine, | |
| | | 2-Ethyl-2,5-dimethylpyrazine, | |
| | | Trimethylpyrazine | |
| Sorbitol | Proline | 2-Acetylpyrroline, | Roasted, |
| | | 2-Acetyl-3,4,5,6-tetra- | Bread- |
| | | hydropyridine, | crust |
| | | 2-Acetyl-1,4,5,6-tetra- | |
| | | hydropyridine, | |
| | | 4-Dimethylaminopyridin-2-amine | |
| Sorbitol | Phenylalanine | Benzaldehyde, 3-Phenylfuran, | Honey |
| | | Phenylacetaldehyde | |
| Sorbitol | Valine | 2-Methylpropanal, | Cheese |
| | | 2,5-Dimethylpyrazine | |

### Example 3

### Flavour Compositions According to the Invention Comprising Different Types of Reducing Sugars

### Recipe

Recipe to produce 4.1 g of flavour composition according to the invention, illustrated with the reducing sugar glucose: A mixture of proline (100.2 mg), glycerol (3409 mg), glucose (10.1 mg) and Vittel water (600 mg) in a round flask was mechanically stirred for 2 h at room temperature and then heated for 2 h in an oil bath preheated at 120° C.

### Analytical Method

The method described in example 1 was applied.

### Flavour Quality

Sensory evaluation of flavour compositions was carried out with a panel of 3 to 6 members as described in Example 1.

### Analytical and Sensory Results

Volatile analysis and technical sniffing were performed as described above. The results are shown in the Table 3.

TABLE 3

| Reducing | | Overall |
|---|---|---|
| sugar | Key volatile compounds | aroma |
| Glucose | 2-Acetylpyrroline, | Biscuit, |
| (1 or 10% | 2-Acetyl-3,4,5,6-tetrahydropyridine, | bread |
| relative | 2-Acetyl-1,4,5,6-tetrahydropyridine, | |
| to proline) | 2-Acetylpyridine | |
| Rhamnose | 2-Acetylpyrroline, | Honey, |
| (1 or 10% | 2-Acetyl-3,4,5,6-tetrahydropyridine, | bread |
| relative | 2-Acetyl-1,4,5,6-tetrahydropyridine, | |
| to proline) | 2-Propionyl-3,4,5,6-tetrahydropyridine, | |
| | 2-Propionyl-1,4,5,6-tetrahydropyridine | |
| Xylose | 2-Acetylpyrroline, | Bread, |
| (1 or 10% | 2-Acetyl-3,4,5,6-tetrahydropyridine, | caramel |
| relative | 2-Acetyl-1,4,5,6-tetrahydropyridine, | |
| to proline) | 5-Acetyl-2,3-dihydropyrrolizine | |

### Example 4

### Baked Wafers with Sugar Comprising Flavour Composition According to the Invention Obtained by Pre-Reacting a Mixture of Proline/Glycerol/Water

### Recipe

Recipe to produce 45 g of flavour composition according to the invention: A mixture of proline (1.098 g), glycerol (37.314 g) and Vittel water (6.579 g) in a round flask was mechanically stirred for 2 h at room temperature and then heated for 2 h in an oil bath preheated at 120° C. After cooling to room temperature, the pre-reacted mixture was used as additional ingredient incorporated to the wafer dough prior to baking to produce test wafers A according to the invention.

### Wafers Preparation

### Wafers Recipe

Wafers were produced according to the following recipe:

| Ingredient | Percentage |
|---|---|
| Wheat flour | 35 |
| Sugar | 11 |
| Butter | 13 |
| Vittel water | 41 |
| Total | 100 |

### Dough Preparation

The wheat flour was mixed with sugar and a pinch of salt in a conventional baker's mixer equipped with a wire whip for 1 min. In parallel, melted butter was mixed with Vittel water pre-heated at 40° C., and the resulting mixture was slowly added during 2 min to the mixer containing the mixture of wheat flour/sugar while maintaining the mechanical mixing.

Optionally, the above pre-reacted flavour composition according the invention was incorporated during the dough preparation prior to baking. Accordingly, a pre-reacted mixture of proline/glycerol/water was incorporated to the dough as an additional ingredient during preparation prior to baking to obtain test wafers A while no flavour composition was incorporated into the dough to obtain control wafers RS.

### Wafers Baking

40 g of the final dough were poured onto the wafer iron (dimension 18×18 cm, Modell Hebenstreit Maschinenbau, Walldorf, Germany). The baking conditions were 180° C. and 1.30 min.

Test and control wafers were produced according to the following recipes:

TABLE 4

| | Test wafers A | Control wafers RS |
|---|---|---|
| Ingredients | (wt %) | (wt %) |
| Wheat flour | 33.25 | 33.30 |
| Sugar | 10.45 | 10.44 |
| Butter | 12.35 | 12.34 |
| Water | 38.95 | 43.92 |
| Pre-reacted mixture of: | 5 | 0 |
| Proline | 0.122 | 0 |
| Glycerol | 4.146 | 0 |
| Vittel Water | 0.731 | 0 |
| Total | 100 | 100 |

### Test Wafers A

Test wafers A were produced using the recipe mentioned in Table 4, by pre-reacting the mixture of proline/glycerol/water by heating it for 2 h in an oil bath preheated at 120° C., and incorporating said pre-reacted mixture as an additional ingredient into the dough during preparation prior to baking.

Control Wafers RS (i.e. without Glycerol Nor Proline)

Control wafers RS were produced using the recipe mentioned in Table 4, with no additional ingredient incorporated into the dough during preparation prior to baking.

### Sensory Tests

Test wafers A according to the invention were compared to control wafers RS by a panel (10 panellists) as described in Example 1. While the control wafers RS overall aroma was qualified as “floury, unbaked, sweet”, the aroma of the test wafers A according to the invention was qualified as “biscuit, milky, vanilla”.

### Example 5

### Baked Wafers with Sugar Comprising Flavour Composition According to the Invention Obtained by Pre-Reacting a Mixture of Monosodium Glutamate/Sorbitol/Water

### Recipe

Recipe to produce 4.1 g of flavour composition according to the invention: A mixture of monosodium glutamate (0.1 g), sorbitol (3.4 g) and Vittel water (0.6 g) in a round flask was heated for 2 h in an oil bath preheated at 120° C. After cooling to room temperature, the pre-reacted mixture was used as an additional ingredient incorporated into the wafer dough prior to baking to produce test wafers A according to the invention.

### Wafers Preparation

### Wafers Recipe

Wafers were produced according to the following recipe:

| Ingredient | Percentage |
|---|---|
| Wheat flour | 35 |
| Sugar | 11 |
| Butter | 13 |
| Vittel water | 41 |
| Total | 100 |

### Dough Preparation

Wheat flour, sugar and a pinch of salt were mixed in a conventional baker's mixer equipped with a wire whip for 1 min. In parallel, melted butter was mixed with Vittel water heated at 40° C., and the resulting mixture was slowly added during 2 min to the mixer containing the mixture of wheat flour/sugar while maintaining the mechanical mixing.

Optionally, the above pre-reacted flavour composition according to the invention was incorporated during the dough preparation prior to baking. Accordingly, a pre-reacted mixture of monosodium glutamate/sorbitol/water was incorporated into the dough as an additional ingredient during preparation prior to baking to obtain test wafers B while no flavour composition was incorporated into the dough to obtain control wafers RS.

### Wafers Baking

40 g of the final dough were poured onto the wafer iron (dimension 18×18 cm, Modell Hebenstreit Maschinenbau, Walldorf, Germany). The baking conditions were 180° C. and 1.30 min.

Test and control wafers were produced according to the following recipes:

TABLE 5

| | Test wafers B | Control wafers RS |
|---|---|---|
| Ingredients | (wt %) | (wt %) |
| Wheat flour | 34.61 | 33.30 |
| Sugar | 10.88 | 10.44 |
| Butter | 12.84 | 12.34 |
| Water | 40.54 | 43.92 |
| Pre-reacted mixture of: | 1.13 | 0 |
| Monosodium glutamate | 0.028 | 0 |
| Sorbitol | 0.937 | 0 |
| Vittel Water | 0.165 | 0 |
| Total | 100 | 100 |

### Test Wafers B

Test wafers B were produced using the recipe mentioned in Table 5, by pre-reacting the mixture of monosodium glutamate/sorbitol/water by heating it for 2 h in an oil bath preheated at 120° C., and incorporating said pre-reacted mixture as an additional ingredient incorporated into the dough during preparation prior to baking.

Control Wafers RS (i.e. without Sorbitol Nor Monosodium Glutamate)

Control wafers RS were produced using the recipe mentioned in Table 5 with no additional ingredient incorporated into the dough during preparation prior to baking.

### Sensory Tests

Test wafers B according to the invention were compared to control wafers RS by a panel (10 panellists) as described in Example 1. While the control wafers RS overall aroma was qualified as “floury, unbaked, sweet”, the aroma of the test wafers B according to the invention was qualified as “biscuit, milky, vanilla”.

### Example 6

### Baked Wafers with No Sugar Comprising Flavour Composition According to the Invention Obtained by Pre-Reacting a Mixture of Proline/Glycerol/Water

### Recipe

Recipe to produce 45 g of flavour composition according to the invention: A mixture of proline (1.098 g), glycerol (37.314 g) and Vittel water (6.579 g) in a round flask was mechanically stirred for 2 h at room temperature and then heated for 2 h in an oil bath preheated at 120° C. After cooling to room temperature, the pre-reacted mixture was used as additional ingredient incorporated to the wafer dough prior to baking to produce wafers according to the invention.

### Wafers Preparation

### Wafers Recipe

Test and control wafers were produced according to the following recipes:

TABLE 6

| Ingredients | Test wafers C | Control wafers RNS |
|---|---|---|
| Water [kg] | 11.1 | 11.1 |
| Sodium Bicarbonate [g] | 22.7 | 22.7 |
| Calcium sulphate [g] | 18.2 | 18.2 |
| Enzyme [g] | 4.0 | 4.0 |
| Pre-reacted flavour composition [g] | 425 | 0 |
| Palm oil [g] | 59 | 59 |
| Flour [kg] | 10 | 10 |

### Dough Preparation

The ingredients for Test wafer C as mentioned in Table 6 and, separately, the ingredients for Control wafers RNS as mentioned in Table 6 were mixed in a conventional baker's mixer equipped with a wire whip at 35° C. and then let rest for 30 min at 35° C. with no stirring.

### Wafers Baking

40 g of the final doughs were poured onto the wafer iron (dimension 18×18 cm, Modell Hebenstreit Maschinenbau, Walldorf, Germany). The baking conditions for wafers of 1.5 mm thickness were 160° C., for 1 min 50 sec.

### Sensory Tests

Test wafers B according to the invention were compared to control wafers RS by a panel (10 panellists) as described in Example 1. While the control wafers RS overall aroma was qualified as “floury, unbaked, sweet”, the aroma of the test wafers B according to the invention was qualified as “biscuit, milky, vanilla”.

The above examples are illustrative of the compositions and methods of making the same falling within the scope of the present invention. They are not to be considered in any way limitative of the invention. Changes and modifications can be made with respect to the invention. That is, the skilled person will recognize many possible variations in these examples covering a wide range of compositions, ingredients, processing methods, and mixtures, and can adjust the naturally occurring levels of the compounds of the invention for a variety of applications.

### SUMMARY OF THE INVENTION

Flavour composition for modulating the flavour of a nutritional product, comprising a mixture of a single amino acid and wet alkane polyol,
   Wherein the single amino acid is selected from the group consisting of ornithine, lysine, glycine, alanine, monosodium glutamate, histidine, threonine, phenylalanine, tyrosine, serine, methionine, arginine, glutamic acid and cysteine.
   wherein the wet alkane polyol is selected from the group consisting of wet glycerol, wet sorbitol, wet xylitol, wet erythritol, wet propane-1,2-diol, wet ethane-1,2-diol, more preferably from the group consisting of wet glycerol, wet sorbitol, wet propane-1,2-diol, and wet ethane-1,2-diol, and most preferably wet glycerol.
   wherein the wet alkane polyol is comprised of alkane polyol and water, preferably in a ratio of from 99:1 to 50:50, more preferably, from 97:3 to 70:30, and most preferably from 96:4 to 80:20.
   wherein the weight ratio of the single amino acid and wet alkane polyol is from 1:10 to 1:100, preferably from 1:20 to 1:80 and more preferably from 1:30 to 1:60.
   wherein the wet alkane polyol and the single amino acid are pre-reacted for a period of 5 minutes to 5 hours, at a temperature of 70 to 250° C.
   which further comprises at least one reducing agent, preferably in an amount of 0.0001 to 1% calculated on the weight of the single amino acid.
   wherein the at least one reducing agent is a reducing sugar, which is preferably selected from the group consisting of mono- di- and oligo-saccharides, more preferably from the group consisting of glucose, rhamnose, fucose, sucrose, maltose, lactose, xylose, ribose, mannose, erythrose, threose and galactose, and most preferably from the group consisting of glucose, rhamnose, fucose, sucrose, xylose, ribose, erythrose and threose.
   wherein the wet alkane polyol is comprised in an amount of from 99.9 to 75 wt %, preferably from 99.5 to 85 wt %, and more preferably from 99 to 90 wt % calculated on the weight of the flavour composition.
   wherein the single amino acid is comprised in an amount of from 0.1 to 25 wt %, preferably from 0.5 to 15 wt %, and more preferably from 1 to 10 wt %, calculated on the weight of the flavour composition.
   wherein the single amino acid is selected from the group consisting of ornithine, lysine and glycine.
   wherein the single amino acid is selected from the group consisting of alanine, monosodium glutamate, glutamic acid, histidine and threonine.
   wherein the single amino acid is phenylalanine.
   wherein the single amino acid is selected from methionine or serine.
   wherein the single amino acid is cysteine.
   wherein the single amino acid is arginine.
   wherein the flavour is selected from: bread, nutty, peanut, cocoa, floral, meaty, sulfury, eggy, grilled, potato, popcorn, caramel, bread crumbs, toasty, bread, old dry wood, cheese, fishy, basmati, biscuit.
Use of such a flavour composition for modulating the flavour and/or flavour shelf-life of a nutritional product.
Use of such a flavour composition for modulating the flavour and/or flavour shelf-life of a nutritional product, wherein the flavour is selected from bread notes.
Use of a flavour composition for modulating the flavour and/or flavour shelf-life of a nutritional product, wherein the flavour is selected from nutty and peanut notes.
Use of a flavour composition for modulating the flavour and/or flavour shelf-life of a nutritional product, wherein the flavour is selected from cocoa and floral aroma.
Use of a flavour composition for modulating the flavour and/or flavour shelf-life of a nutritional product, wherein the flavour is selected from meaty notes.
Use of a flavour composition for modulating the flavour and/or flavour shelf-life of a nutritional product, wherein the flavour is selected from sulfury and eggy notes.
Use of a flavour composition for modulating the flavour and/or flavour shelf-life of a nutritional product, wherein the flavour is selected from fishy and cheese notes.
Use, wherein the nutritional product is preferably selected from the group consisting of bakery products, confectionery products, preferably ice confectionery products, most preferably ice cream; savoury products, cereal products, preferably baked cereal products and/or extruded cereal products, dairy products, petfood products, preferably baked petfood products and/or extruded petfood products and beverages.
Use, wherein the nutritional product is a bakery product, preferably a wafer or a biscuit and most preferably a wafer cone.
Process for preparing a flavour composition, comprising
   (a) Preparing a mixture comprising
      i. wet alkane polyol, preferably in an amount of from 99.9 to 75 wt %, more preferably from 99.5 to 85 wt %, and even more preferably from 99 to 90 wt %, calculated on the weight of the flavour composition,
      ii. a single amino acid, preferably in an amount of from 0.1 to 25 wt %, more preferably from 0.5 to 15 wt %, and even more preferably from 1 to 10 wt %, calculated on the weight of the flavour composition, and
      iii. optionally at least one reducing agent, preferably in an amount of 0.0001% to 1% calculated on the weight of the single amino acid;
   wherein the single amino acid is selected from the group consisting of ornithine, lysine, glycine, alanine, monosodium glutamate, histidine, threonine, phenylalanine, tyrosine, serine, methionine, arginine, glutamic acid and cysteine;
   (b) Optionally adjusting the pH of the mixture, preferably to a pH of from 6.5 to 8.0, more preferably to a pH of from 7 to 7.9;
   (c) Heating the mixture in water, preferably for a period of 5 minutes to 5 hours, preferably at a temperature of from 70° C. to 250° C.;
   (d) Optionally adjusting the pH of the heated mixture, preferably to a pH of from 6.5 to 8.0, more preferably to a pH of from 7 to 7.9.
Process, wherein the at least one reducing agent is a reducing sugar, which is preferably selected from the group consisting of mono- di- and oligo-saccharides, more preferably from the group consisting of glucose, rhamnose, fucose, sucrose, maltose, lactose, xylose, ribose, mannose, erythrose, threose and galactose, and most preferably selected from the group consisting of glucose, rhamnose, fucose, sucrose, xylose, ribose, erythrose and threose.
Process, wherein the wet alkane polyol is selected from the group consisting of wet glycerol, wet sorbitol, wet xylitol, wet erythritol, wet propane-1,2-diol, wet ethane-1,2-diol, more preferably from the group consisting of wet glycerol, wet sorbitol, wet propane-1,2-diol, and wet ethane-1,2-diol, and most preferably wet glycerol.
Process, wherein the wet alkane polyol is comprised of alkane polyol and water, preferably in a ratio of from 99:1 to 50:50, more preferably from 97:3 to 70:30, and most preferably from 96:4 to 80:20.
Process, wherein the weight ratio of the single amino acid and wet alkane polyol is from 1:10 to 1:100, preferably from 1:20 to 1:80 and more preferably from 1:30 to 1:60.
Process for modulating the flavour and/or flavour shelf-life of a nutritional product, comprising
   (e) Preparing one or more flavour compositions by the process according to any of claims 26 to 30, and
   (f) Incorporating the one or more flavour compositions into the nutritional product, preferably prior to cooking and/or processing of said product.
Process, wherein the nutritional product is preferably selected from the group consisting of bakery products, confectionery products, preferably ice confectionery products, most preferably ice cream, savoury products, cereal products, preferably baked cereal products and/or extruded cereal products, dairy products, petfood products, preferably baked petfood products and/or extruded petfood products and beverages.
Process, wherein the flavour is selected from: bread, nutty, peanut, cocoa, floral, meaty, sulfury, eggy, grilled, potato, popcorn, caramel, breadcrumbs, toasty, bread, old dry wood, cheese, fishy, basmati, biscuit.
Nutritional product comprising a flavour composition, wherein the nutritional product is preferably selected from bakery products, confectionery products, preferably ice confectionery products, most preferably ice cream, savoury products, cereal products, preferably baked cereal products and/or extruded cereal products, dairy products, petfood products, preferably baked petfood products and/or extruded petfood products and beverages.
Nutritional product, wherein the nutritional product is a bakery product, preferably a wafer or a biscuit and most preferably a wafer cone.

1. Flavor composition for modulating the flavor of a nutritional product, comprising a mixture of a single amino acid and wet alkane polyol,
the single amino acid is selected from the group consisting of ornithine, lysine, glycine, alanine, monosodium glutamate, histidine, threonine, phenylalanine, tyrosine, serine, methionine, arginine, glutamic acid and cysteine.

2. Flavor composition according to claim 1, wherein
the wet alkane polyol is selected from the group consisting of wet glycerol, wet sorbitol, wet xylitol, wet erythritol, wet propane-1,2-diol, wet ethane-1,2-diol, more preferably from the group consisting of wet glycerol, wet sorbitol, wet propane-1,2-diol, and wet ethane-1,2-diol.

3. Flavor composition according to claim 1, wherein the wet alkane polyol comprises alkane polyol and water.

4. Flavor composition according to claim 1, wherein the weight ratio of the single amino acid and wet alkane polyol is from 1:10 to 1:100.

5. Flavor composition according to claim 1, comprising at least one reducing agent.

6. Flavor composition according to claim 1, wherein the at least one reducing agent is a reducing sugar.

7. Flavor composition according to claim 1, wherein the single amino acid is comprised in an amount of from 0.1 to 25 wt %, calculated on the weight of the flavor composition.

8. Flavor composition according to claim 1, wherein the single amino acid is selected from the group consisting of ornithine, lysine and glycine.

9. Flavor composition according to claim 1, wherein the flavor is selected from the group consisting of: bread, nutty, peanut, cocoa, floral, meaty, sulfury, eggy, grilled, potato, popcorn, caramel, bread crumbs, toasty, bread, old dry wood, cheese, fishy, basmati, and biscuit.

10. A method for modulating the flavor and/or flavor shelf-life of a nutritional product, comprising adding a mixture of a single amino acid and wet alkane polyol,
the single amino acid is selected from the group consisting of ornithine, lysine, glycine, alanine, monosodium glutamate, histidine, threonine, phenylalanine, tyrosine, serine, methionine, arginine, glutamic acid and cysteine and has a flavor selected from the group consisting of:
bread notes;
nutty and peanut notes;
cocoa and floral aroma;
meaty notes;
sulfury and eggy notes; and
fishy and cheese notes to the nutritional product.

11. Method according to claim 10, wherein the nutritional product is selected from the group consisting of bakery products, confectionery products, ice confectionery products, savoury products, cereal products, dairy products, petfood products, and beverages.

12. Process for preparing a flavor composition, comprising
preparing a mixture comprising
wet alkane polyol, in an amount of from 99.9 to 75 wt %, calculated on the weight of the flavor composition,
a single amino acid, preferably in an amount of from 0.1 to 25 wt %, calculated on the weight of the flavor composition, and
at least one reducing agent,
wherein the single amino acid is selected from the group consisting of ornithine, lysine, glycine, alanine, monosodium glutamate, histidine, threonine, phenylalanine, tyrosine, serine, methionine, arginine, glutamic acid and cysteine.

13. Process according to claim 12, wherein the at least one reducing agent is a reducing sugar.

14. Process according to claim 12, wherein the wet alkane polyol is selected from the group consisting of wet glycerol, wet sorbitol, wet xylitol, wet erythritol, wet propane-1,2-diol, and wet ethane-1,2-diol.

15. Nutritional product comprising a flavor composition for modulating the flavor of a nutritional product, comprising a mixture of a single amino acid and wet alkane polyol,
the single amino acid is selected from the group consisting of ornithine, lysine, glycine, alanine, monosodium glutamate, histidine, threonine, phenylalanine, tyrosine, serine, methionine, arginine, glutamic acid and cysteine, wherein the nutritional product is selected from the group consisting of bakery products, confectionery products, savoury products, cereal products, dairy products, petfood products, and beverages.

16. Process according to claim 12 comprising:
adjusting the pH of the mixture;
heating the mixture in water; and
adjusting the pH of the heated mixture.

17. Process according to claim 12, wherein the wet alkane polyol comprises alkane polyol and water; and
the weight ratio of the single amino acid and wet alkane polyol is from 1:10 to 1:100.
